(19) United States
(12) Patent Application Publication
(10) Pub. No.: US 2009/0154426 A1
(43) Pub. Date: Jun. 18, 2009

(54) HANDOVER BASED ON A QUALITY OF SERVICE METRIC OBTAINED FROM A MAC LAYER OF A RECEIVED SIGNAL

(75) Inventors: Eric Perraud, Tournefeuille (FR); Bruno Galmar, Toulouse (FR)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: FREESCALE SEMICONDUCTOR, INC., Austin, TX (US)

(21) Appl. No.: 12/063,422

(22) PCT Filed: Aug. 9, 2005
(86) PCT No.: PCT/EP2005/009960

§ 371 Date: Feb. 8, 2008

(51) Int. Cl. H04W 36/30; H04W 36/00

(52) U.S. Cl. 370/332; 455/436

(57) ABSTRACT

A wireless communication unit comprises a receiver operably coupled to a signal processing function arranged to make a hand-over determination based on a communication signal received from a serving communication station. The signal processing function is arranged to perform a hand-over operation based on at least one quality of service metric(s) obtained from a medium access control layer of a received signal.

The embodiments comprise identifying an optimal hand-over candidate that enables a more effective hand-over from a first WLAN to a second WLAN or a cellular system.

### FIELD OF THE INVENTION

This invention relates to wireless communication systems wireless communication units and a method for hand-over. In particular, the invention relates to wireless local area network (WLAN) and hand-over from a first WLAN access point to a second WLAN access point or a cellular wireless communication system.

### BACKGROUND OF THE INVENTION

Over recent years, the development in wireless communications has been dramatic. A number of wireless communications have been standardised, to facilitate inter-operability of communications between different technologies and different manufacturers, as well as ensure that all communication units offer a particular level of performance. One technology to undergo such rapid development and standardisation is Wireless Local Area Networks (WLANs). WLANs have been targeted to provide wireless connectivity at bit rates higher than 10 Mbps. WLANs also offer the opportunity of enhanced security, etc. Thus, WLAN technology is anticipated as playing a key role in the wireless data market for many years to come.

Furthermore, WLANs are currently being enhanced to provide a guaranteed quality of service (QoS), as can be seen in IEEE Std. 802.11e/D6.0, “Part 11: Wireless Medium Access Control (MAC) and physical layer (PHY) specifications: Medium Access Control (MAC) Quality of Service (Qos) Enhancements”, November 2003. This is a further reason as to why WLAN solutions for voice and video services are quickly emerging in the data marketplace.

Wireless cell-based communication systems, for example cellular mobile phone communication systems, provide for radio telecommunication links to be arranged between a system infrastructure that includes a plurality of base transceiver stations (BTSs) and a plurality of remote wireless subscriber units or terminals, often termed mobile stations (MSs). In particular, information communicated between the BTS and MS may represent speech, sound, data, picture or video information. In addition, signalling messages are communicated. Different channels may be used for communication of the different forms of information.

The third generation partnership project (3GPP) is defining a standard (‘3GPP43.318’) for future wireless communication units to inter-operate between a cellular communication system (such as a global system for mobile communication (GSM) network referred to as a GERAN) and a WLAN. Handover of an on-going communication between the two communication systems is a requirement, where handover from WLAN to a GERAN is specified as being under the control of the mobile (subscriber) unit and handover from a GERAN to WLAN is specified as being under control of the infrastructure.

However, the standard does not specify the criteria to be used in making the handover decision, such as what metrics should be used to trigger the handover, or what the handover procedure should be.

It is known that in order to support an efficient and substantially seamless handover process between communication systems, the handover time should be as short as possible and the mobile should preferably hand-over from a first WLAN access point (AP) to a second WLAN AP, if possible prior to considering hand-over to a neighbouring GERAN. This concept of seamless mobility allows the mobile unit to select the best radio access network (WLAN or cellular) to provide a particular level of service. Thus, the mobile may make a decision in an attempt to reduce communication costs or to improve a quality of service or to increase the communication coverage range.

The majority of known mechanisms propose sensing a received signal's power (often referred to as a received signal strength indicator (RSSI)) of a WLAN base station or a cellular BTS as a metric. This value is then used to trigger roaming from one WLAN base station to another or to trigger handover to a neighbouring cellular network when the received signal power drops below a threshold. Such a metric is usually used to estimate the link quality with the current base station and of the neighbouring cells.

However, the inventors have recognised and appreciated that such a RSSI parameter as a metric suffers from a number of major drawbacks. First, a mobile unit may decide to hand-over to a WLAN AP that is nearby but that is unable to offer an expected Quality of Service due to limited bandwidth. Secondly, the requirement to scan all the WLAN channels will typically be very time consuming and be a significant drain on current in a portable wireless communication unit.

Thirdly, the use of such a metric often results in a ‘ping-pong’ effect, with continuous handover between the WLAN AP and the cellular network. Such an event occurs when the mobile unit is in a local deep WLAN null for a short period of time, i.e. it is unable to receive and decode a signal for short period of time. Consequently, the mobile unit leaves the WLAN network too ‘early’.

Fourthly, it is possible for a mobile unit to receive a high level (RSSI) signal from the WLAN AP where the quality of service may be very poor due to excess WLAN network load or if other subscriber units are transmitting (or receiving) services with higher priority. Thus, it may be appropriate for the mobile unit to hand-over to the cellular network to maintain the expected quality of service. However, as the mobile unit typically employs a received signal strength metric, it would fail to identify that a hand-over would be appropriate.

In addition to, or as an alternative to, measuring RSSI, a mobile unit may measure packet error rate (PER). However, the mobile unit needs to perform measurements over a large number of packets to provide an accurate measurement. Furthermore, this may take a long time if the downlink (DL) traffic communication rate, i.e. communication from the BTS to the mobile unit, is low. This invariably leads to the time required to predict hand-over being too long.

In addition, PER measurements are also dependent upon the available bandwidth of the serving WLAN station and on the network load (as well as the percentage of collisions). Also, the PER does not degrade gracefully versus received power, as the PER suddenly drops when received power is below a given threshold, i.e. when the mobile unit is at a WLAN cell boundary. Thus, in practice, it is difficult to use this metric in a meaningful way as it is difficult to know whether PER degradation is due to movement out of the WLAN cell coverage or whether it is due to packet collisions. Such a metric also suffers from the same drawback as the RSSI metric in that it does not provide any estimation of the expected Quality of Service of the WLAN access point that the subscriber will register with after handover. Furthermore, if the PER metric is used to trigger hand-over and to ‘sense’ the neighbouring cells, it assumes that a physical link is created with these neighbouring base stations. Thus, it is a waste of subscriber energy and subscriber processing capacity/resource to create such physical links, only to test them for possible handover.

The document titled ‘Efficient Mobility management for vertical handoff between WWAN and WLAN’, authored by Qian Zhang, Chuanxiong Guo, Zihua Guo & Wenwu Zhu; and published in IEEE communications magazine in November 2003’ proposes predicting the available bandwidth of neighbour WLAN access points. However, this estimation is biased, because it does not take into account priority of WLAN connections as defined in lie. Thus, it is likely to result in incorrect decisions.

US Patent Application 20040203788 and US Patent Application 20040146024 describe hand-over mechanisms from a cellular network to a WLAN at a protocol stack level, but not at physical level.

Motorola™ proposes an enhanced passive scan mechanism with their Integrated Digital Enhanced Network (iDEN™) product, where scanning of adjacent WLAN APs are performed before any hand-over operation is performed. However, the proposed method ranks WLAN APs based solely on the received power, and as such the selection of the newly joined AP is unlikely to be the optimum choice. Thus, the decision for hand-over is only based on the radio frequency (RF) measurement.

Thus, a need exists for an improved communication system, associated communication units and method to perform hand-over, preferably from a first WLAN AP to a second WLAN AP or a cellular network, wherein the abovementioned disadvantages/limitations may be alleviated.

### SUMMARY OF THE INVENTION

In accordance with embodiments of the present invention, there is provided a wireless communication unit and method of performing a hand-over, as defined in the appended Claims.

### BRIEF DESCRIPTION OF THE ACCOMPANYING DRAWINGS

Embodiments of the present invention will now be described by way of example only, with reference to the accompanying drawings, in which:

FIG. 1 illustrates a schematic block diagram of a WLAN inter-operating with a cellular communication system and adapted to support the embodiments of the present invention;

FIG. 2 illustrates a wireless communication unit adapted in accordance with the embodiments of the present invention;

FIG. 3 shows a graph illustrating the use of thresholds in the embodiments of the present invention;

FIG. 4 illustrates a method of performing hand-over between a first WLAN AP and a second WLAN AP or a cellular communication system, according to the embodiments of the present invention; and

FIG. 5 illustrates further steps in the method of performing hand-over between a first WLAN AP and a second WLAN AP or a cellular communication system, according to the embodiments of the present invention.

### DESCRIPTION OF EMBODIMENTS OF THE INVENTION

Embodiments of the present invention propose measuring a current downlink quality of service metric of target (candidate) WLAN APs by decoding the received signal from the candidate WLAN AP at a medium access control (MAC) layer. The metric is then used to predict whether sufficient available bandwidth exists per neighbour WLAN AP. The measurements and metrics are preferably combined in an algorithm to manage and optimise the hand-over process.

In summary, the prediction of available bandwidth of scanned APs is estimated on a traffic per priority type basis. For this purpose, the subscriber unit monitors the WLAN traffic volumes per level of priority. These WLAN traffic volumes are combined in such a manner that traffic volumes of higher priority than the priority level of the service of the subscriber will be weighted with a high weight, and traffic volumes of lower priority than the subscriber's service will have a low weight. In this manner, the subscriber estimates the available bandwidth it can expect, by essentially estimating the bandwidth that is used by devices it is competing against, i.e. devices with services of the same or higher priority. Preferably, the prediction also factors in the mobile unit's priority, as defined in 802.11e. Thus, in this manner, there is no drop in Quality of Service after hand-over to a new WLAN AP, as the target AP has apriori been determined as having sufficient bandwidth to support the desired service.

Advantageously, an embodiment of the present invention is focused on scanning channels that have a lower likelihood of discovering suitable WLAN Access Points (for example in adjacent or overlapping channels) with a lower duty cycle. In this manner, a lower current drain in a background scan mode is achieved.

Additionally, and advantageously, dual metric types are used, comprising a combination of WLAN radio frequency (RF) and Medium Access Control (MAC) layer measurements. Finally, the use of adaptive thresholds is used in a dedicated hand-over algorithm. Such use of adaptive thresholds and a dedicated hand-over algorithm assists in avoiding a ‘ping-pong’ effect in continuously switching between the WLAN and cellular networks if the mobile unit enters a very local deep WLAN fade for a short period of time.

An embodiment of the present invention preferably resides in a dual-mode GSM or EDGE /WLAN subscriber phone. Notably, prior to any hand-over to a cellular network, the mobile unit attempts to roam to a WLAN AP that is anticipated as having sufficient bandwidth to support the desired service.

In this regard, the mobile unit is connected to its WLAN network as long as possible, thereby providing faster and less expensive services than a comparable cellular network. Furthermore, the hand-over decision is based on the level of service, as perceived by the user, thereby providing a direct comparison between WLAN cell coverage and Quality of Service.

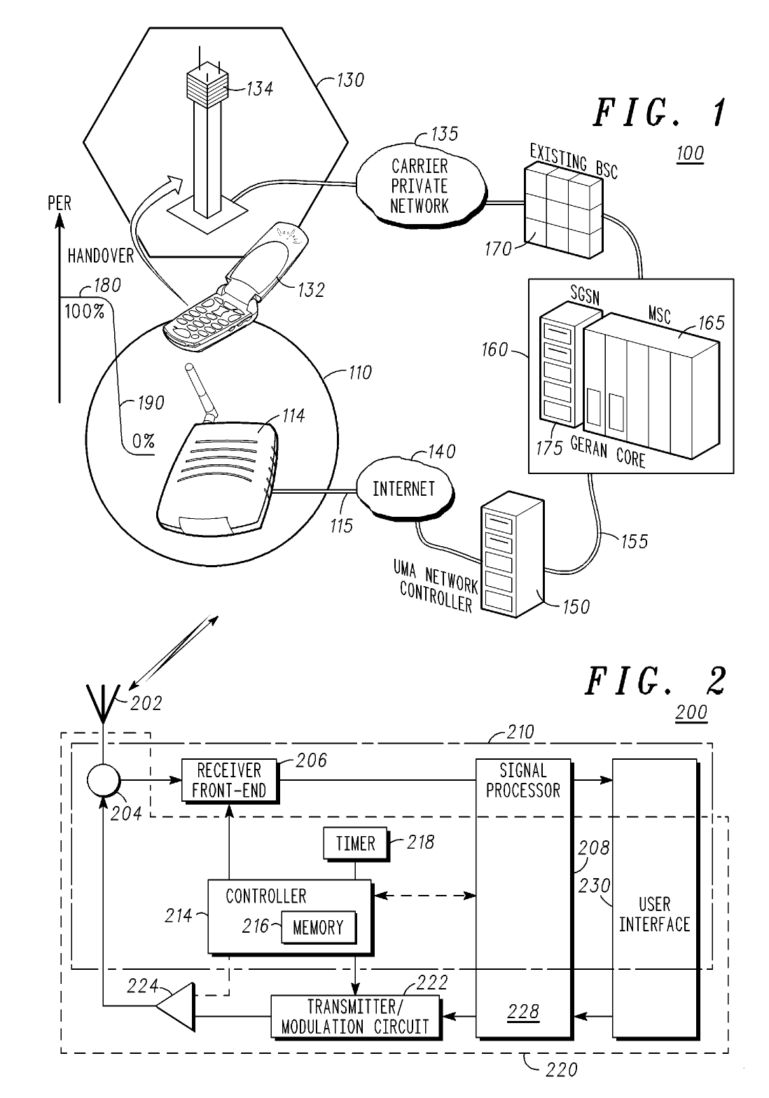

In summary, the embodiments of the present invention propose to integrate WLAN technology with a cellular radio system, such as a 2^{nd} generation (2G) Global system for mobile communication (GSM) or a 2.75G system such as EDGE, as defined by the European Telecommunication Standards Institute (ETSI). A proposed system configuration of both a WLAN inter-operating with a Geran core is illustrated in the schematic block diagram of FIG. 1. For completeness, it is also envisaged that the embodiments herein described are applicable to the inter-working of WLAN networks and Utran networks, which will be defined by the well-known 3^{rd} Generation Partnership Project (3GPP).

An embodiment of the present invention proposes a dual-mode wireless communication unit. The dual-mode operation utilises a first cellular mobile phone technology, such as EDGE, and a second WLAN technology. Each wireless communication terminal 132 interfaces with the Geran core 160 over a WLAN radio interface 115 and through a UMA or Generic Access Controller 150. Alternatively, the wireless communication terminal 132 interfaces with the Geran core 160 over a carrier private network 135, via a conventional GSM base transceiver station (BTS) 134 over a conventional base switching controller 170 and input to the Geran Core 160. The Geran core 160 comprises a Service GPRS Switching Node (SGSN) and a main switching controller (MSC) 165 as known in the art. Thus, a dual-mode cellular and WLAN supported terminal is described.

In the context of the present invention, the dual-mode subscriber unit 132 may be any kind of wireless communication device with a WLAN interface, namely, a personal computer (PC), laptop, PDA, dual-mode WLAN/cellular terminal, etc.

Advantageously, the characteristics of the WLAN cellular radio interface 115 enable extended WLAN capabilities and new features, such as high-speed data services, simultaneous voice and data, and improved voice quality, etc. Thus, cellular wireless communication terminals benefit from known advantages of WLAN technology.

The WLAN site 110, which can be considered as a geographical area where WLAN coverage is provided, is controlled by a single WLAN Access Gateway (not shown). A WLAN site 110 typically comprises one or more access points APs 114. The cellular wireless communication terminal 132 has a wireless interface to the WLAN AP 114. The WLAN AP 114 interfaces with WLAN terminals over any kind of WLAN interface, for example using IEEE 802.11 WLAN technology, as published by IEEE in the document titled “Wireless LAN Medium Access Control (MAC) and Physical Layer (PHY) Specification”, IEEE standard 802.11, edition 1999. The WLAN AP has an interface 115 to the Internet Protocol (IP) network 140 via one or more WLAN Access Gateways (not shown). The IP network 140 is operably coupled to the Geran core 160 via a key UMA or Generic access (GA) Network controller 150, configured to interface 155 to the Geran core 160. The UMA Network controller 150 also interfaces with one or more further WLAN Access Gateways (WAGs) (not shown). In effect, the WAG is a router, or a combination of router and Ethernet Switches to control a single WLAN site. The WAG interfaces with one or more APs 114 typically through an Ethernet 100-BaseT medium.

The UMA Network controller 150 uses known IP multicasting technology to transfer control packet data units (PDUs) and voice packets to the dual-mode communication terminals 132. The improved management of a handover process is performed in the wireless cellular communication unit, often referred to as a wireless subscriber communication unit. The embodiments of the present invention will be described in terms of a wireless subscriber communication unit capable of dual mode WLAN and cellular operation in accordance with the EDGE or 3GPP standard. However, it will be appreciated by a skilled artisan that the embodiments herein described may be embodied in any dual mode WLAN and cellular context.

Referring now to FIG. 2, a wireless subscriber communication unit is described that has been adapted in accordance with an embodiment of the present invention. The wireless communication unit 200 comprises an antenna 202, preferably coupled to a duplex filter or antenna switch 204 that provides isolation between a receiver chain and a transmitter chain within the wireless communication unit 200. As also known in the art, the receiver chain typically includes a receiver front-end circuit 206 (effectively providing reception, filtering and intermediate or base-band frequency conversion). The receiver front-end circuit is serially coupled to a signal processing function 208, typically implemented as a digital signal processor (DSP). An output from the signal processing function 208 is provided to a suitable user interface, which preferably comprises an output device 210, such as a speaker and/or display, and an input device, such as a microphone and/or keypad.

The user interface 230 is operably coupled to a memory unit 216, via link 236, and a timer 218 via a controller 214. The controller 214 is also coupled to the receiver front-end circuit 206 and the signal processing function 208. The controller 214 may therefore receive bit error rate (BER), packet error rate (PER) or frame error rate (FER) data from recovered information. The controller 214 is coupled to the memory device 216 for storing operating regimes, such as decoding/encoding functions and the like. A timer 218 is typically coupled to the controller 214 to control the timing of operations (transmission or reception of time-dependent signals) within the wireless communication unit 200.

As regards the transmit chain, the input device is coupled to a transmitter/modulation circuit 222 via the signal processing function 208 (or 228 if the transmit and receive portions were distinctly implemented). Thereafter, the transmit signal is passed through a power amplifier 224 to be radiated from the antenna 202. The transmitter/modulation circuit 222 and the power amplifier 224 are operationally responsive to the controller, with an output from the power amplifier coupled to the duplex filter or antenna switch 204. The transmitter/modulation circuitry 222 and receiver front-end circuitry 206 comprise frequency up-conversion and frequency down-conversion functions (not shown).

In summary, in accordance with an embodiment of the present invention, the wireless subscriber unit has been adapted in the following manner. Whilst in a WLAN mode of operation, the signal processing function 208 and/or the controller 214, in conjunction with the receiver front-end circuit 206 of the wireless subscriber unit, is/are arranged to perform regular active background scanning on WLAN communication channels.

Notably, the scanning is preferably performed at a plurality of different scan rates. In particular, a shorter scan duty cycle is adopted for the one or more non-overlapping WLAN channels, which are deemed to be the most likely channels where the wireless subscriber unit will detect WLAN access points. In contrast, a longer scan duty cycle is adopted for other WLAN channels that are deemed to have a lower likelihood of supporting the desired level of service. Advantageously, the lower duty cycle background scan drains less current, as preferably only the better candidate non-overlapping channels are scanned at a higher duty cycle/short scanning rate.

Scanning of neighbour WLAN APs is performed in order to predict the effective available bandwidth (EAB) per scanned AP, based on the level of traffic and on the existing service priority. The signal processing function 208 of the wireless subscriber unit 200 computes the effective available bandwidth (EAB) as a metric, which weights each type of medium occupancy with a scale (weighting) factor. These weighted values are stored in memory 216.

Within the memory 216, the weighted values are preferably ranked according to the potential APs with regard to the received power and EAB. Preferably, ranking of the scanned WLAN APs includes an estimation of the bandwidth, which will be available for the desired service, taking into account the subscriber communication unit's service priority and priorities of other served WLAN APs. In this manner, selection of the target WLAN AP to hand-over to is more reliable.

When scanning a channel, the wireless subscriber unit senses the strength (level) of the WLAN received signal, for example preferably sensing the power level of the probe response frame from the AP. The probe response frame is preferably used as it forces the AP to reply. Hence, the subscriber unit will know if there is an AP on a particular channel and it will estimate the RSSI, SNIR, etc. of the AP. Other mechanism/frame types may be used, but are deemed generally less efficient than the probe response frame.

Notably, the physical layer measurements are used in addition to the MAC metric measurement. For example, SNIR measurement provides a better correlation with PER in a real radio channel (that exhibits multipath fading) than RSSI. SNIR measurements are performed in-band, preferably at the modem input, and are performed on any AP frame (either a broadcast frame or any frame) whether intended for the wireless subscriber unit or not. In addition, a measurement may be based on estimating the WLAN link quality with Shannon capacity, for example by performing channel equalization in a frequency domain. It is known that PER variance for a given Shannon capacity is smaller than the SNIR variance for a Rayleigh fading channel. Hence, the use of Shannon capacity is deemed a more accurate metric.

In addition, and notably, the wireless subscriber unit also monitors the medium occupancy per priority type. In this regard, priority type can be understood according to the following scenario. WLAN packets are placed in different transmit queues depending on their required quality of service. High QoS services are mapped on high priority transmit queues, providing them faster access to the medium and, hence, higher bandwidth. This priority level information is included in the WLAN Medium Access Control (MAC) header. Thus, the wireless subscriber unit monitors the medium occupancy by sensing packets of same priority level.

Thus, the wireless subscriber unit receives and decodes a probe response frame to identify a ‘priority type’ of the medium access control (MAC) part of the communication, as located within the MAC header. In this manner, the wireless subscriber unit is configured to detect downlink WLAN QoS degradation due to, say, excessive WLAN network load resulting in throughput degradation or excessive packet latency or jitter as well as downlink QoS degradation due to the wireless subscriber unit being located at a WLAN cell boundary.

Thus, the wireless subscriber unit is arranged to monitor dual metrics, in both the RF (physical layer) and MAC layer of the current WLAN connection, which allows RF link quality estimation and Quality of Service estimation to be made.

Thus, in addition to the scanning operation, the signal processing function 208 and/or the controller 214, in conjunction with the receiver front-end circuit 206 of the wireless subscriber unit, is/are arranged to perform a monitoring operation of the current WLAN connection, again with, say, two metrics :
(i) Signal-to-noise (SNR) or received power strength of the received signal; and
(ii) MAC metrics, which preferably combine:
   (a) Downlink throughput,
   (b) Estimated downlink latency, and
   (c) Jitter.

Again, these monitored values are ranked with weights depending upon the service being utilised. Advantageously, an embodiment proposes utilising two distinct types of metrics for handover decision, e.g. a combination of radio frequency (RF) measurements are used to estimate the WLAN coverage and MAC measurements to estimate the quality of service in a weighted, ranking manner. This mechanism improves the likelihood of handing-over communication to a system that is best suited to support the desired communication.

In accordance with an embodiment of the present invention, the optimal metrics for hand-over are designed to meet a particular Quality of Service (QoS) level that the user is expecting. In this regard, the QoS may be defined using two or more of the following:
(i) Packet Error Rate (PER) which depends on the radio communication channel and on the received signal strength. This is one of the known physical layers (RF metrics);
(ii) Throughput, which depends on the bandwidth available for the desired service, for example the WLAN network load and hence the risk of collision. Throughput also depends upon the mobile or AP data rate capability. In addition, throughput depends upon the priority assigned to the desired service, versus other services that the AP is serving. Furthermore, the throughput is dependent upon the level of pre-emption on the WLAN channel, for example how many other WLAN devices are pre-empting the WLAN channel.

Throughput, therefore, is preferably measured by the signal processor as:

$$Throughput = MAC\_payload \_size * \frac{No . of acknowledged packets}{Observation\_window} \qquad [ 1 ]$$

where the number of acknowledged packets comprises the number of packets that are passed to the signal processor.
(iii) Packet latency. There is no simple mechanism to measure the mean latency of a received packet due to network load, as the wireless subscriber unit is unable to estimate the time when the AP initially wanted to transmit a particular packet. However, the document titled ‘Efficient Mobility management for vertical handoff between WWAN and WLAN’, authored by Qian Zhang, Chuanxiong Guo, Zihua Guo & Wenwu Zhu; and published in IEEE communications magazine in November 2003’ proposes predicting the available bandwidth of neighbour WLAN access points. This document has demonstrated that mean packet latency is highly correlated to the mean received throughput. Thus, mean delay within an observation window can be estimated via a throughput measurement.
(iv) Packet jitter, which can be interpreted as a random process whose probability distribution function, depends on the occupied bandwidth. The wireless subscriber unit's signal processor is able to readily compute time intervals δi (i=1 . . . n) between two successive received and acknowledged packets, within an observation window. Hence, packet jitter can be quantified as the variance of δi variables.

When the scan is complete, the signal processor of the wireless subscriber unit preferably determines, and stores the following information, per AP:
(a) SNIR;
(b) AP identifier (say its SSID) and security features; and
(c) EAB.

The signal processor then ranks the APs, dependent upon the service and the expected QoS.

Therefore, in accordance with an embodiment of the present invention, it is proposed to perform a hand-over decision process based on a ranking of both a physical layer metric, such as SNIR or PER and one or more series of MAC metrics that combine a number of, and occasionally all, these DL measurements. Preferably, the metrics include a weighting factor. A preferred algorithm is provided below:

MAC_metrics=ω₁*throughput/Max_theo_throughput+ω₂*Min_Theo_delay/delay+ω₃*jitter*Average_Inter_packet_interval [2]

where:
Max_theo_throughput is the expected throughput if there were no other wireless subscriber unit's communicating to the AP; and
Average_Inter_packet_interval is the mean interval between receptions of successive packets.

Preferably, the ωᵢ weights are application specific. Thus, for some services such as web page downloading, jitter or delay may not be relevant while throughput may. In contrast, for applications such as VoIP, it is envisaged that the MAC metrics of jitter and delay will be used, as these are important for successful receipt of VoIP packets.

It is noteworthy that the three MAC metrics are related to the available bandwidth for the subscriber communication unit.

In respect of a GSM or EDGE implementation for the cellular system the UMA Network Controller (UNC) or the Generic Access Network Controller (GANC) may send a ‘URR_Uplink_Quality_Indicator’, which indicates an IP network problem or a radio problem of the AP. In this regard, the UNC manufacturer decides what criteria are used to report the Uplink quality. This known criterion applies to a WLAN to GERAN handover. However, and notably, the uplink quality is reported from the AP side. This is in contrast to the above embodiment of the present invention where the handover decision is based on subscriber unit detected measurements. Furthermore, the subscriber unit may make handover decision (WLAN to GERAN) and then decide whether or not to follow up on any report from the UNC. Consequently, the wireless subscriber communication unit is informed of any QoS degradation in either the IP network or uplink WLAN communication link due to, say, radio coverage or link problems.

In the document titled ‘Efficient Mobility management for vertical handoff between WWAN and WLAN’, authored by Qian Zhang, Chuanxiong Guo, Zihua Guo & Wenwu Zhu; and published in IEEE communications magazine in November 2003’ the authors propose to use ‘NAV’ as an indicator of available bandwidth. NAV is the Network allocation vector and is part of the well known 802.11 specification to obtain access to the wireless medium. The NAV indicator can be understood as the percentage of time when the WLAN medium is busy and occupied by traffic of other devices. It is therefore a good predictor for available bandwidth.

However, the inventors of the present invention have identified that use of ‘NAV’ as a QoS metric is not accurate in all situations. To explain the potential inaccuracy, let us consider that a first WLAN wireless subscriber unit may not detect communications from a second WLAN wireless subscriber unit if the second WLAN wireless subscriber unit does not pre-empt the WLAN channel with, say, a clear-to-send (CTS) frame. Thus, the serving AP will send a return-to-sender (RTS) frame that the first wireless subscriber unit will detect and that indicates how long the medium (channel) is pre-empted by another WLAN wireless subscriber unit.

A normal mode of operation is where transmissions of large packets are protected against collisions by medium pre-emption with CTS frames. Hence, using a NAV metric by the first wireless subscriber unit will detect that WLAN bandwidth is allocated to the communication with the second wireless subscriber unit, although it is unable to detect transmissions made by the second wireless subscriber unit.

However, such a mechanism to predict the available bandwidth suffers from a major drawback in that it assumes that all packets have the same priority and are equally able to access the medium. Thus, the ‘NAV’ metric does not take into account that ‘11e’ packets do not have the same probability for obtaining access to the channel.

Consequently, an embodiment of the present invention proposes to use the following metric, termed effective available bandwidth (EAB) to predict the bandwidth that the wireless subscriber unit expects:

$$E A B = 1 - a * \frac{1}{Observation\_time} {\sum }_{i = 1}^{4} {ω}_{i} * N A V ( i ) \qquad [ 3 ]$$

where
a is a scaling coefficient
NAV(i) is the cumulative time when the ‘NAV’ metric indicates a busy medium for each of the priority packet types; for example high priority packets, such as voice (VO) packets are mapped to i=1, packets such as video (VI) packets are mapped to i=2, Best Effort packets are mapped to i=3 and Background packets are mapped to i=4.
ωᵢ represents a number correlated to the expected probability to get access to the channel for my service.

In a first, rough approximation, ωᵢ is calculated as follows:

ωᵢ=βᵢ/my_β [4]

where:
β₁=4
β₂=2
β₃=1
β₄=1
where my_β takes one of. these values, depending on the service being provided, for example if it is a voice service, my_{—}β=4.

However, it is envisaged that other computations of the ωᵢ coefficients may be employed, which utilise alternative priority definitions.

The βᵢ set represents the relative probability of obtaining access to the channel at the first transmission attempt, per priority type. It is expected that the βᵢ ratios will be larger when retries are considered.

When scanning other WLAN channels, the wireless subscriber unit monitors the communication medium (i.e. the communication channel). When the wireless subscriber unit detects a packet transmission, it reads the QoS field in the MAC header of this transmitted packet to identify the priority type of the current transmission. The wireless subscriber unit also reads the packet duration in the MAC header of the current transmission. In response to these monitoring and reading operations, the wireless subscriber unit updates the NAV(i) according to the following formula:

New_NAV(i)=Old_NAV(i)+Read_duration [5]

This improved NAV metric better reflects what will occur in reality with WLAN lie data packets having different priorities.

By utilising an improved NAV metric in determining the effective available bandwidth (EAB), the EAB takes into account undetected frames from remote stations. Thus, when a remote station pre-empts the communication medium by sending a CTS message, the wireless subscriber unit is able to estimate how long this remote station will pre-empt the communication medium. In this case, it is irrelevant as to the priority type of the pre-empting remote station, as the wireless subscriber unit is unable to access the WLAN communication medium. Thus, the time associated with NAV=busy after a CTS message is preferably included as a part of NAV(1), in equation [5] above.

A skilled artisan will appreciate that there is a trade-off between current consumption and the time required to estimate EAB with reasonable accuracy. This trade-off defines time per scanned channel and the probe frame delay. It has been determined that an optimum scanning time is less than 20 msec if the wireless subscriber unit is supporting a voice over Internet protocol (VoIP) service, where 8 msec is deemed sufficiently long to receive responses (with a 95% success rate) of three APs per channel operating a file transfer protocol (FTP) transfer. Advantageously, this active scan may be arranged between beacons of the existing AP transmissions to the wireless subscriber unit, or between VoIP bursts.

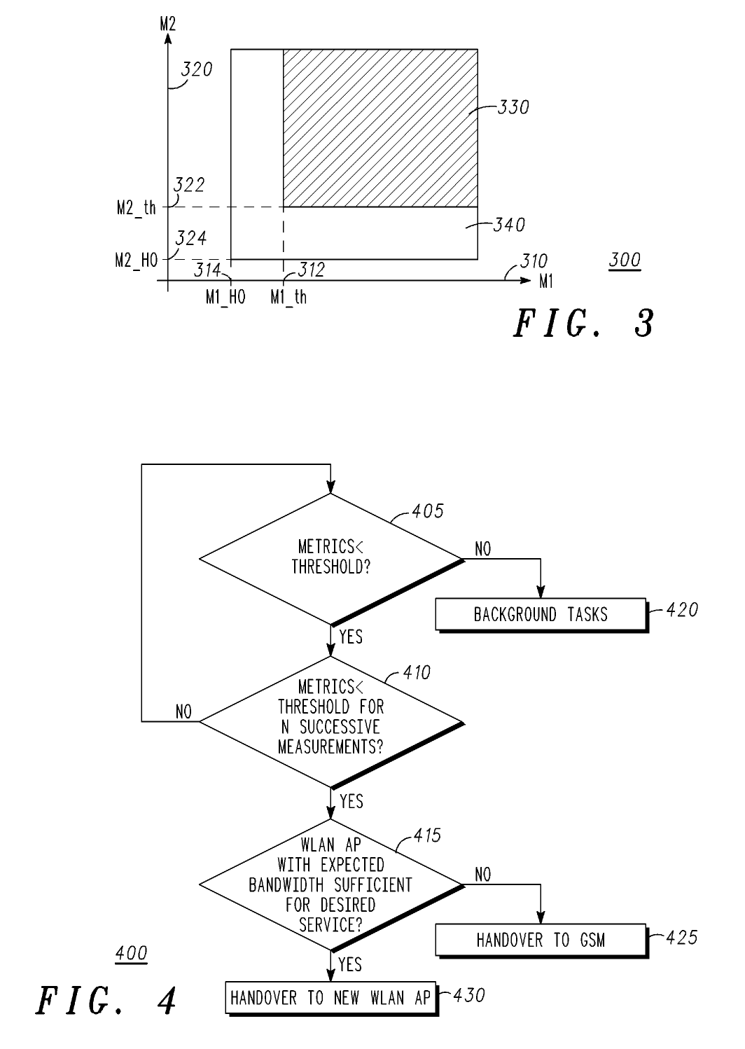

Referring now to FIG. 3, a graph 300 illustrates the use of physical layer (RF) thresholds M1 310 and MAC layer thresholds M2 320, in accordance with an embodiment of the present invention. Area 330 is recognised as a reasonable level of communication between the wireless subscriber unit and the existing WLAN AP. When operating in this area 330, the wireless subscriber unit minimizes current consumption by periodically scanning adjacent non-overlapping channels with a ‘T1’ period. Preferably, the wireless subscriber unit scans other channels with a period ‘T2’, where T2>>T1.

The signal processing function 208 preferably defines two adaptive thresholds (M1_HO and M2_HO) associated with each metric, dependent upon the service and required QoS for this service:
(i) Threshold ‘1’=min_threshold+offset ‘1’; and
(ii) Threshold ‘2’=min_threshold+offset ‘2’;
where the offset is preferably a ratio metric related to the speed of change. Thus, each of the metrics is compared to adaptive thresholds. Notably, and advantageously, the handover thresholds are updated (as described below) for each measured change in the performance of each WLAN channel and the service provided to the wireless subscriber communication unit.

When one of the adaptive thresholds is reached, the thresholds are preferably frozen. If the metric is decreasing for N successive measurements, then the subscriber communication unit 132 will hand-off either to the highest ranked WLAN AP, if the EAB meets the required Quality of service, or alternatively to a suitable cellular network. Advantageously, and in this manner, the handover decision is arranged such that the wireless subscriber communication unit 200 remains safely connected to the WLAN network for as long as possible.

In accordance with an embodiment of the present invention, the adaptive thresholds are updated in alignment with the speed of change of each metric. That is, if M1 (or M2) is dropping smoothly; a small guard-band may be used to allow the wireless subscriber unit sufficient time to make a hand-over decision. If M1 is dropping at a fast rate, the guard-band is preferably configured to be higher, as the time to make a hand-over decision may be shorter, assuming that a seamless service is desired.

$$\begin{matrix}M 1 \_th = M 1 \_HO + \frac{\partial M 1}{\partial t} * Δ t \& M 2 \_th \\ = M 2 \_HO + \frac{\partial M 2}{\partial t} * Δ t\end{matrix} \qquad [ 6 ]$$

where:
Δt is the time which is needed for hand-over decision.

Let us assume that we want at least N metric updates in the region 330. When the wireless subscriber unit is associated with, and expecting data from, its serving AP, the wireless subscriber unit is configured to wake-up to receive, at least, every beacon signal.

### Hence:

Δt=N*beacon_periods [7]

If the adaptive offset is null or negative, it is replaced by a minimum positive value.

When the metric calculation drops below the M1 or M2 thresholds, the back-ground scanning is preferably performed at a reduced duty cycle period of T3, where T3<<T1.

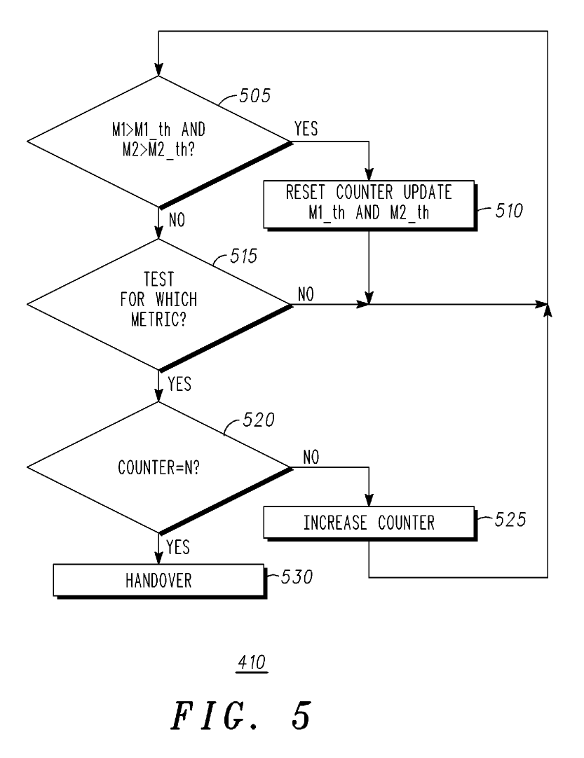

Referring to FIG. 4, a flowchart 400 illustrates a hand-over method according to an embodiment of the present invention. The metrics calculation (as described previously) is continuously performed to identify whether any of the metrics is less than the respective threshold value 312 or 322 of FIG. 3, as shown in step 405. If the metrics calculation is not less than the threshold value in step 405, the aforementioned background scanning tasks are continued, as shown in step 420.

When a metric calculation is less than a respective threshold value, a counter is started. If the metric calculation is not less than the threshold value, for N successive measurements in step 410, the wireless subscriber unit determines that it is not time to initiate a hand-over operation and loops back to step 405. Thus, as soon as the metric calculation returns to a reasonable level, say area 330 in FIG. 3, the counter is reset and the Mᵢ thresholds are updated with the Mᵢ change slope.

However, if N successive measurements show that the MAC (or RF) metric calculation is still less than the respective threshold value, in step 410, the wireless subscriber unit determines that it is time to initiate a hand-over operation. Notably, whilst the metric calculation is between the threshold levels, the counter is increased. The likelihood is that the metric calculation is decreasing, and therefore the threshold values are frozen.

In this manner, the wireless subscriber unit remains on a WLAN network for as long as possible whilst remaining within the WLAN cell boundary. This is in contrast to known hand-over mechanisms that would perform a hand-over potentially too early. Furthermore, by use of a counter mechanism before hand-over operation is initiated, it is possible for the wireless subscriber unit to enter a very deep, but very local, transmission fade, for a short time, and still remain associated with the same WLAN AP.

By use of adaptive thresholds, in contrast to the known use of fixed value thresholds, a much smaller threshold region 340 can be used. Advantageously, background scanning can be performed at much slower rates than with fixed thresholds, leading to a substantial saving in power consumption for the wireless subscriber unit.

Following a determination that it is time to hand-over in step 410, the wireless subscriber unit checks whether the highest ranked AP meets the requirements of the currently supported service, e.g. whether it supports the desired bandwidth, as shown in step 415. If the highest ranked AP meets the requirements of the currently supported service in step 415, the wireless subscriber unit performs a hand-over to the new WLAN AP, in step 430. If the highest ranked WLAN AP does not meet the requirements of the currently supported service in step 415, the wireless subscriber unit performs a hand-over to a GERAN, in step 425.

Referring now to FIG. 5, the step of determining whether to perform a hand-over operation 410 is described in greater detail. A determination is made as to whether both the RF (M1) and MAC layer (M2) metrics are greater than the respective adaptive threshold, as shown in step 505. If both the RF (M1) and MAC layer (M2) metrics are greater than the respective adaptive threshold in step 505, a counter is reset and the respective thresholds may be updated based on the aforementioned criteria, as shown in step 510.

If either the RF (M1) or MAC layer (M2) metrics are less than or equal to the respective adaptive threshold, in step 505, the following sub-routine is performed in step 515:

Test M_{1,I} if M_{1,I}<M1_th, else test M 2,i. [8]

This enables the respective metric that is below the threshold level to be identified. If the test fails, i.e. both metrics are now identified as being above the threshold, the process loops back to step 505. If either metric is equal to or below the respective adaptive threshold in step 515, the counter is checked to see if it has reached the appropriate time period, i.e. counter=‘N’, as shown in step 520. If the counter has not reached ‘N’, in step 520, the counter is incremented in step 525, and the process loops back to step 505. If the counter has reached ‘N’, a hand-over decision is made in step 530, as described previously, with respect to FIG. 4.

In this manner, a counter is used to identify a period of time that one or more metrics have fallen below a respective adaptive threshold. The use of an adaptive threshold allows a better decision as to whether to hand-off to be made. The use of both RF and MAC layer metrics facilitate a better decision as to whether the target hand-over candidate WLAN AP, or alternative cellular BTS or system, will support the desired QoS.

It will be understood that the aforementioned wireless communication unit and system and method for hand-over, as described above, tend to provide at least one or more of the following advantages:
(i) Provides for a much more robust method of determining when a hand-off should occur. Ranking of neighbour WLAN APs is performed during background scanning, which includes prediction of the effective available bandwidth. The predicted EAB advantageously takes into account the priorities of the traffic on the network. Hence, the subsequent hand-over decision (to a new WLAN or to a GERAN) is more reliable and should offer a seamless transition of services. In contrast, if the embodiments hereinbefore described in predicting the effective bandwidth was not performed, the subscriber communication unit may decide to hand-over to a WLAN AP that is unable to offer the required bandwidth, thereby resulting in a QoS degradation.
(ii) A subscriber communication unit is connected to a WLAN network as long as possible before hand-over to a cellular GERAN, for example. In this manner, the subscriber communication unit does not hand-over when entering a deep RF null, or if the QoS drops, for a brief period of time.
(iii) The metrics used in the handover decision combine measurements about WLAN coverage as well as received DL QoS. Significantly, these metrics equate to the performance perceived by the end user. Thus, taking the factors into account enhances the effective QoS that the user perceives.
(iv) Improves effective data rate available to user over varying conditions.
(v) Fewer missed handoffs.
(vi) More efficient data rate utilization, whilst retaining a low current drain, due to the use of different background scan rates.
(vii) The proposed method utilizes available WLAN bandwidth metrics as well as the standard received signal power strength to ensure the desired quality of service is provided by the target hand-off AP.

Whilst specific implementations of the present invention have been described, it is clear that one skilled in the art could readily apply further variations and modifications of such implementations within the scope of the accompanying claims.

Thus, a wireless communication system, a wireless subscriber unit and a method of hand-over have been described to alleviate the aforementioned disadvantages of prior art systems, communication units and hand-over procedures.

1-39. (canceled)

40. A wireless communication unit comprising:
a receiver operably coupled to a signal processing function arranged to make a hand-over determination based on a first communication signal received from a serving communication station and a second communication signal received from one or more candidate serving stations, wherein the signal processing function is arranged to predict whether an available bandwidth provided by the one or more candidate serving stations is sufficient to meet a future communication need of the wireless communication unit and performs a hand-over operation based on at least one quality of service metric(s) obtained from a medium access control (MAC) layer of the first received signal from the current serving communication unit and the predicted available bandwidth provided by the one or more candidate serving stations.

41. A wireless communication unit according to claim 40, wherein the serving communication station is a wireless local area network access point and hand-over is performed from a first WLAN AP to a second WLAN AP or a cellular communication system.

42. A wireless communication unit according to claim 40, further comprising weighting logic operably coupled to the signal processing function arranged to apply a weight to the at least one quality of service metrics according to a measurement associated with the received signal.

43. A wireless communication unit according to claim 40, wherein the signal processing function is arranged such that the prediction of whether the available bandwidth is sufficient is based on one or more of:
(i) The traffic per priority type supported by the serving station; and
(ii) A priority rating of the wireless communication unit or desired service of the wireless communication unit.

44. A wireless communication unit according to claim 40, wherein the signal processing function is arranged such that the predicting the available bandwidth for the wireless communication unit for the candidate serving station incorporates a probability of obtaining access to the channel.

45. A wireless communication unit according to claim 44, wherein the signal processing function is arranged such that the predicting the available bandwidth for the wireless communication unit for the candidate serving station is of the form of a linear equation, where each term of the equation that comprises a value associated with a service provided to the wireless communication unit and a probability of accessing a communication medium supporting a desired traffic type.

46. A wireless communication unit according to claim 45, wherein the signal processing function is arranged such that the predicting the available bandwidth for the wireless communication unit for the candidate serving station combines a percentage of traffic per type of priority and a number that is correlated to a probability of accessing a communication medium for the considered type of traffic relative to a probability of accessing the communication medium for the wireless communication unit's service.

47. A wireless communication unit according to claim 45, wherein the signal processing function is arranged such that the predicting the available bandwidth for the wireless communication unit for the candidate serving station is of the form:
$$E A B = 1 - a * \frac{1}{Observation\_time} {\sum }_{i = 1}^{4} {ω}_{i} * N A V ( i ) .$$
where NAV(i) is a means to estimate a traffic volume per type of priority
“a” is a scaling coefficient;
“l” indicates a mapping of data packets; and
“ω” is a weighting factor that indicates a probability that traffic ‘i’ type will obtain access to the communication medium.

48. A wireless communication unit according to claim 40, wherein the at least one quality of service metric(s) comprises a plurality of medium access control layer measurements of the received signal.

49. A wireless communication unit according to claim 40, wherein at least one quality of service metric(s) based on a medium access control (MAC) layer is of the form:
MAC_metrics=a₁*throughput/Max_theo_throughput+a₂*Min_Theo_delay/delay+a₃*jitter*Average_Inter_packet_interval
where ai are application-specific coefficients and define a perceived application quality of service.

50. A wireless communication unit according to claim 40, wherein at least one quality of service metric(s) additionally comprises a physical radio frequency layer measurement of the received signal.

51. A wireless communication unit according to claim 40, wherein the wireless communication unit is arranged to detect a quality of service degradation of a signal transmitted by the serving station based on one or more of the following:
(i) Throughput degradation;
(ii) Downlink packet latency;
(iii) Jitter; or
(iv) Downlink QoS degradation due to location at a WLAN cell boundary.

52. A wireless communication unit according to claim 40, wherein the signal processing function rates the quality of service metric(s) obtained from a medium access control (MAC) layer with weights depending upon the service being utilized.

53. A wireless communication unit according to claim 40, wherein the signal processing function is arranged such that at least one metric(s) is/are compared to a corresponding at least one adaptive threshold(s) to determine when to perform a hand-over operation.

54. A wireless communication unit according to claim 53 wherein a timer unit is operably coupled to the signal processing function to determine whether one or more of the metric(s) falls below a corresponding at least one adaptive threshold(s) over a period of time.

55. A wireless communication unit according to claim 54 wherein at least one adaptive threshold(s) is updated dynamically depending on a speed of change of the one or more metric.

56. A wireless communication unit according to claim 44 wherein the signal processing function is operably coupled to a memory element for storing records of candidate serving stations in a ranked order according to their predicted available bandwidth.

57. A wireless communication unit according to claim 40, wherein the wireless communication unit performs a hand-over operation in response to a desired level of service by the user of the wireless communication unit.

58. A wireless communication unit according to claim 40, wherein the wireless communication unit is a dual-mode GSM or EDGE or WCDMA /WLAN subscriber phone.

59. A method of handing over communication from a first wireless serving station to a second wireless serving station, the method comprising the step of:
receiving a first communication signal from a serving communication station; and
receiving a second communication signal from one or more candidate serving station;
decoding the first communication signal to identify at least one quality of service metric(s) obtained from a medium access control layer of the received first communication signal;
decoding the one or more second communication signal to predict whether an available bandwidth provided by the one or more candidate serving station is sufficient to meet a future communication need of the wireless communication unit; and
making a hand-over determination based on the predicted available bandwidth provided by the one or more candidate serving station and the at least one quality of service metric(s) obtained from a medium access control layer of the first received signal.
